(19) United States
(12) Patent Application Publication
(10) Pub. No.: US 2010/0307870 A1
(43) Pub. Date: Dec. 9, 2010

(54) TELESCOPIC LADDER

(76) Inventor: Dirk Zimmerman, Dusseldorf (DE)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/794,060

(22) Filed: Jun. 4, 2010

(30) Foreign Application Priority Data
Jun. 5, 2009 (DE) DE 202009007991.0

(51) Int. Cl. E06C 1/12; E06C 1/38; E06C 7/06; E06C 7/08

(52) U.S. Cl. 182/195

(57) ABSTRACT

A telescopic ladder having two mutually adjacent side rails and rungs disposed between the side rails, wherein the side rails include a plurality of substantially tubular, telescoping side rail portions and mutually adjacent side rail portions connected to one another by a rung wherein the side rail portions have a locking unit with which the side rail portions can be locked against the respectively next lower side rail portion in the extended setting.

### CROSS-REFERENCE TO RELATED APPLICATIONS

This application claims priority under 35 U.S.C. 119 to German Utility Model Application No. 20 2009 007 991.0, entitled “Teleskopierbare Leiter” filed Jun. 5, 2009, the disclosure of which is incorporated herein in its entirety.

### FIELD OF THE INVENTION

The present invention relates to a telescopic ladder.

### BACKGROUND OF THE INVENTION

Telescopic ladders are currently used in all fields in which high flexibility is demanded and only little storage space is available. In the present case, the domestic field is uppermost within this context. This should not be construed, however, in a restrictive sense.

The known ladder (EP 0 527 766 B1) on which the invention is based is usually configured with two mutually adjacent side rails and with rungs disposed between the side rails. The side rails respectively consist of a plurality of tubular side rail portions which telescope into one another. Two mutually adjacent side rail portions are respectively connected to one another by a rung.

As a result of the telescoping side rail portions, the ladder can be brought as a whole into a retracted setting and into an extended setting. In the retracted setting, all side rail portions are fitted one inside the other such that, with the exception of the bottommost rung, all the rungs lie close together. In the retracted setting, the ladder is compact and can be easily transported and stored.

In each of the rungs are found locking units, with which the side rail portions assigned to the rung can be locked in relation to the respectively next higher side rail portion. The side rail can be locked as a whole in its extended setting.

For the release of the locking, it is provided in the known ladder that the grouping together of two rungs is accompanied by the release of the locking of the side rail portions assigned to the next higher rung. The retraction of the ladder can thus be achieved in the sense of a domino effect.

A drawback with the known ladder is the fact that the retraction of the ladder cannot be controlled at will. Once released, the ladder must always be brought into the fully retracted setting. This is disadvantageous in terms of convenience of use and user safety.

The problem on which the invention is founded is to configure and refine the known telescopic ladder in such a way that the convenience of use and user safety are enhanced.

### SUMMARY OF THE INVENTION

The above problem is solved in a ladder described herein.

It is firstly proposed that the side rail portions respectively have a locking unit, with which the side rail portions can be locked against the respectively next lower side rail portion in the respectively extended setting.

Of fundamental importance in this context is the recognition that the locking units can be released in a simple manner by means of an actuating shaft which runs longitudinally within the respective side rail and which is engaged with or can be brought into engagement with at least one locking unit. The actuating shaft is correspondingly assigned to a manual actuating device.

Of particular advantage in the proposed solution is the fact that the actuating shaft can be brought purposefully into engagement with predetermined locking units, to be precise in dependence on the telescoping position of the ladder. A particularly convenient usage system can thus be set, as will further be shown.

In one embodiment, the actuating shaft is engaged with the locking unit of the topmost extended side rail portion, and not with locking units of other extended side rail portions. This means that only the respectively topmost extended side rail portion can be released by means of the actuating shaft. This means, in turn, that the retraction of the ladder is effected by means of the actuating device rung for rung, beginning with the topmost rung, in the order from top to bottom, in steps. Each step is associated with an actuation of the actuating device. The retraction of the ladder can thus be interrupted at any time for further use of the ladder.

In another embodiment, it is the case that, in the retraction of a side rail portion, its locking unit enters into engagement with the locking unit of the next lower side rail portion, whereupon, in the following actuating step, these two locking units are coupled together. According to another embodiment, the locking units of all retracted side rail portions are then coupled together.

With the latter, preferred variant, it can easily be achieved that, when the ladder is not fully extended, a coherent, indivisible rung pack can be formed solely at the upper end of the ladder. This also complies with the prevailing safety regulations, since such a rung pack located at the lower end of the ladder can form a trip hazard for the user.

### BRIEF DESCRIPTION OF THE FIGURES

The invention is explained in greater detail below with reference to an illustrative embodiment. In the drawing:

FIG. 1 shows a proposed ladder a) in the retracted setting, b) in a partially retracted setting, and c) in the extended setting, respectively in a side view,

FIG. 2 shows the upper portion of the ladder according to FIG. 1 in a perspective representation,

FIG. 3 shows an exemplary representation of the step-by-step retraction of the ladder according to FIG. 1 a) in the extended setting, b) in a partially retracted setting and c) in the retracted setting, respectively in a perspective representation,

FIG. 4 shows the ladder according to FIG. 1 a) in the retracted setting and b) in a partially retracted setting, respectively in a partially sectioned side view,

FIG. 5 shows the ladder according to FIG. 1 in the extended setting in a partially sectioned side view,

FIG. 6 shows two mutually adjacent side rail portions, connected by a rung, of the ladder according to FIG. 1,

FIG. 7 shows a side rail of the ladder according to FIG. 1 in the region A a) without actuation and b) given actuation which only cancels the blocking, respectively in a partially sectioned side view,

FIG. 8 shows a side rail of the ladder according to FIG. 1 in the region A) a) given actuation which releases the locking and b) during the retraction of the there upper side rail portion, respectively in a partially sectioned side view,

FIG. 9 shows a side rail of the ladder according to FIG. 1 in the region B following the retraction of the there upper side rail portion a) without actuation and b) given actuation which only cancels the blocking, respectively in a partially sectioned side view,

FIG. 10 shows a side rail of the ladder according to FIG. 1 in the region B) a) following the retraction of the there upper side rail portion given actuation which releases the locking and b) given the retraction of the there lower side rail portion, respectively in a partially sectioned side view,

FIG. 11 shows a locking unit of the ladder according to FIG. 1 in a first exploded representation, and

FIG. 12 shows the locking unit according to FIG. 11 in a second exploded representation.

### DETAILED DESCRIPTION

The proposed ladder is equipped in an intrinsically conventional manner with two mutually adjacent side rails 1 and with rungs 2 disposed between the side rails 1.

With a view to a simplified representation, mention is sometimes made below to only a single side rail 1. Since the two side rails 1 are identically constructed, all statements apply, however, always to both side rails 1.

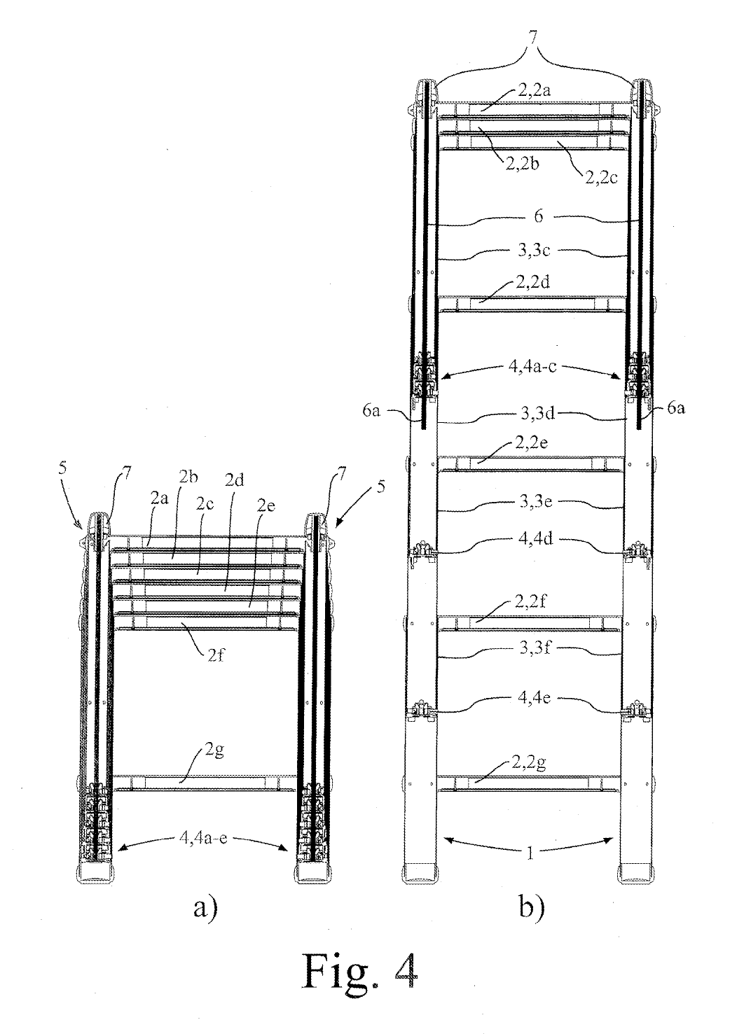

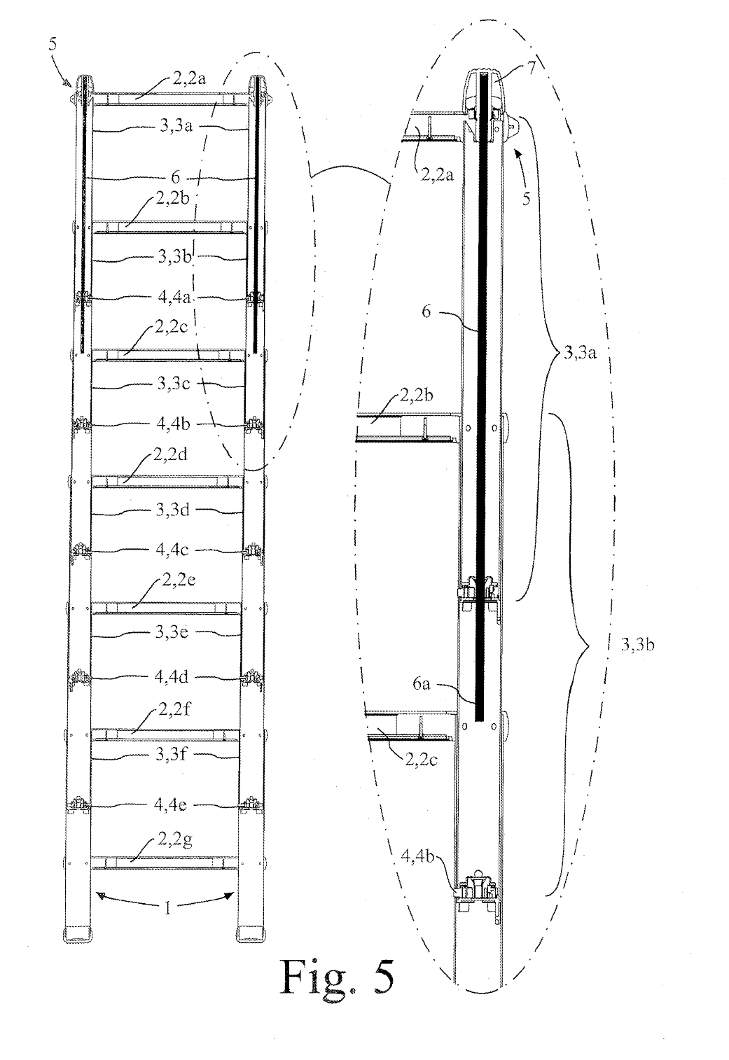

It should further be pointed out that for rungs 2, side rail portions 3 and locking units 4, the reference symbols 2, 3 and 4 are fundamentally used in the present case. In places, however, the specific reference symbols 2a, 2b . . . , 3a, 3b . . . , 4a, 4b . . . indicated in FIGS. 4 and 5 are also used in order to be able to illustrate specific issues.

Finally, it should be pointed out that by the wording “retraction of a side rail portion 3” is meant that the side rail portion 3 in question is retracted telescopically into the next lower side rail portion 3. Other side rail portions 3 are not affected thereby.

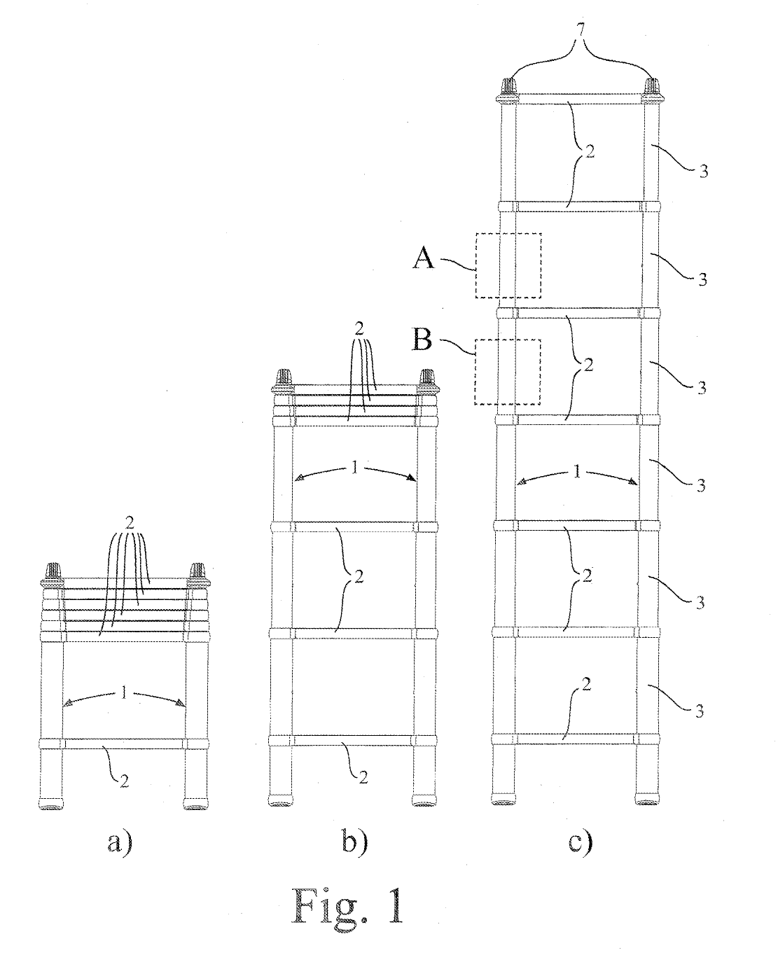

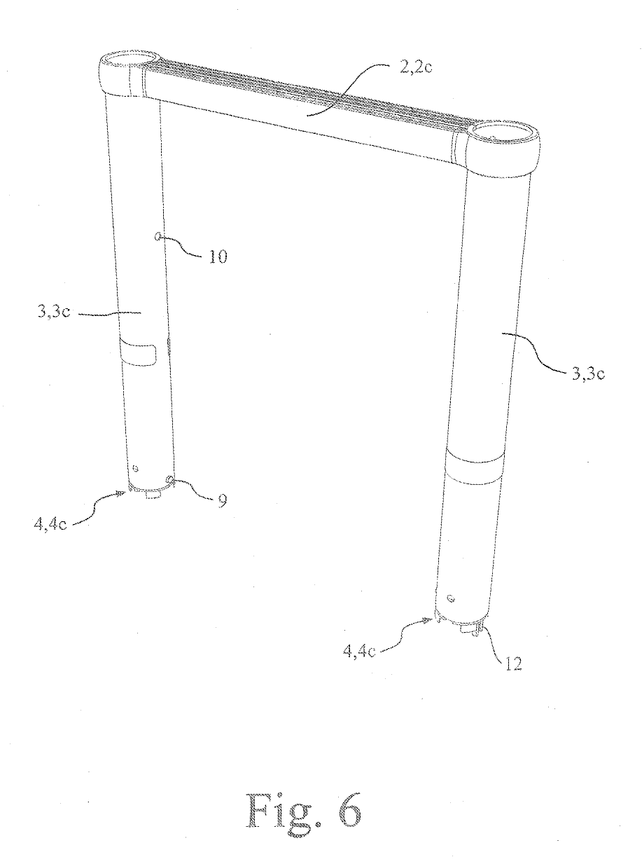

The side rails 1 respectively consist of a plurality of substantially tubular, telescoping side rail portions 3, mutually adjacent side rail portions 3 being respectively connected to one another by a rung 2. This can be seen from a combined view of FIGS. 1 and 6.

The side rail portions 3 respectively have a locking unit 4, with which the side rail portions 3 can be locked against the respectively next lower side rail portion 3 in the respectively extended setting. An exception is formed by the fixed side rail portion 3f, which naturally cannot be retracted into a next lower side rail portion. Finally, it is here a question of the bottommost side rail portion 3f, to which a foot element of the ladder is assigned. The two bottommost side rail portions 3f are additionally connected to each other by an initial rung 2g (FIG. 5).

With the exception of the bottommost side rail portions 3f, all side rail portions 3 extend from the assigned rung 2 downward to the assigned locking unit 4. The locking units 4 are thus preferably disposed at the lower end of the respective side rail portions 3. This is shown also in FIG. 6. From the representation in FIG. 5, the extent of all other side rail portions 3 is correspondingly revealed.

FIG. 1a) shows the retracted setting of the ladder, in which all side rail portions 3 are retracted. FIG. 1b) shows a partially retracted setting, in which only the side rail portions 3a-c are retracted and in which the other side rail portions 3d, e are locked against the respectively next lower side rail portions 3e, f. FIG. 1c) shows the extended setting of the ladder, in which the side rail portions 3a-e are locked to the respectively next lower side rail portions 3b-f.

Of interest in the present case is that to the two side rails 1 there is respectively assigned a manual actuating device 5 for the release of the locking units 4, and that the actuating device 5 has an actuating shaft 6, which runs along within the respective side rail 1 and which, particularly in dependence on the telescoping position of the ladder, is engaged with or can be brought into engagement with at least one locking unit 4. A combined view of FIGS. 4 and 5 shows that the actuating shaft 6 can be engaged only with the locking unit 4a or with further locking units 4, according to the telescoping position of the ladder.

In order to be able to accomplish the above engagement of the actuating shaft 6 in dependence on the telescoping position of the ladder, it is firstly provided that the locking units 4 are additionally rigidly connected to the side rail portions 3. If, therefore, a side rail portion 3 is retracted or extended, then the associated locking unit 4 executes the same motion.

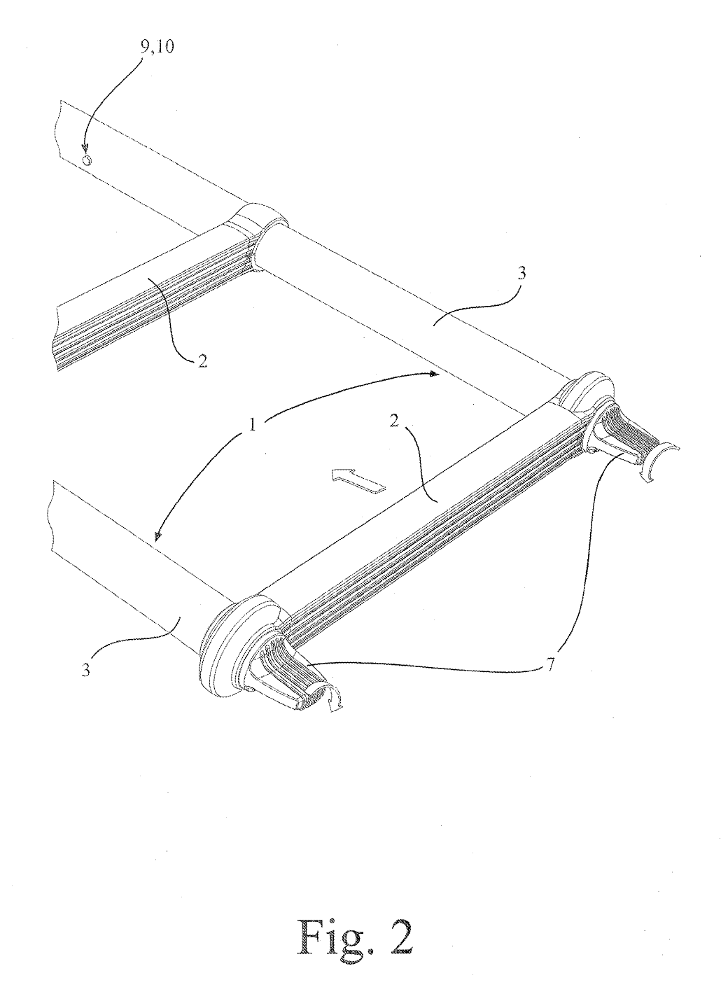

Also of interest in connection with the use of the above actuating shaft 3 is the fact that the actuation is preferably effected from the upper end of the ladder. In the light of this, the actuating device 5 has at the upper end of the respective side rail 1 respectively a rotary actuating handle 7, which is drive-coupled to the actuating shaft 6. Here and preferably, the rotary actuating handle 7 is mounted straight onto the actuating shaft 6. A rotation of the rotary actuating handle 7 leads correspondingly to a rotation of the actuating shaft 6 and, ultimately, to the release of the respective locking units 4. The rotary actuating motion and the subsequent retraction motion are represented by arrows in FIG. 2. By the term rotary motion are here understood, quite generally, both rotary motions in the narrower sense and swivel motions.

From the representation in FIG. 5, it is apparent that the actuating shaft 6 there extends downward from the upper end of the respective side rail 1 with a free end 6a, here and preferably the actuating shaft 6 being mounted in an axially secure and rotatable manner in the topmost side rail portion 3a. Here it is also the case that the actuating shaft 6 follows the retraction of the topmost side rail portion 3a.

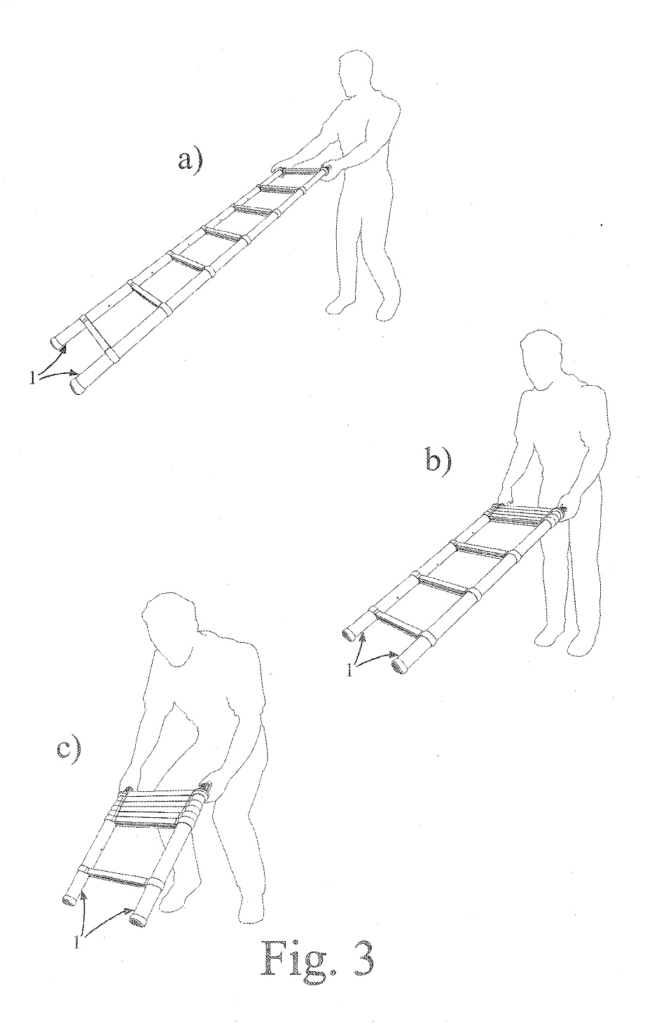

The process involved in retracting the ladder by means of the rotary actuating handles 7 disposed at the upper end of the ladder is shown by FIG. 3. Starting from the extended setting (FIG. 3a)), the user actuates both rotary handles 7 simultaneously, according to the representation in FIG. 2. During the retraction of the topmost side rail portions 3a, he releases the actuation, whereby the rotary actuating handle 7 and the actuating shaft 6 preferably snap back. When the topmost rung 2a then hits the next lower rung 2b, it performs a further actuating step, whereby the next lower side rail portions 3b are released. The operation is repeated until, via the setting represented in FIG. 3b), the fixed rung 2f is finally reached.

It is already apparent from the above explanation that a quite particular importance is attached to the design of the length of the actuating shaft 6 for the working of the ladder. Here and preferably, it is the case that the actuating shaft 6 is designed particularly in terms of its length such that it is engaged with the locking unit 4 of the respective topmost extended side rail portion 3, and not with locking units 4 of other extended side rail portions 3. It is thereby ensured that only the respectively topmost extended side rail portion 3 is releasable with the actuating device 5. This corresponds to the process involved in retracting the ladder, which process is represented in FIG. 3.

The length of the side rail portions 3 is preferably about 1.5 times the distance between two rungs 2 when the ladder is extended. An overlap of the side rail portions 3 of about half the distance between two rungs 2 is thereby ensured, which is of importance to the stability of the ladder. Alternatively or additionally, it can be provided that the length of the actuating shaft is about twice the distance between two rungs 2 when the ladder is extended. In any event, it is here necessarily the case that the length of the actuating shaft 6 is smaller than the height of the ladder in its retracted setting.

Starting from the extended setting of the ladder represented in FIG. 5, an actuation of the actuating device 5 now effects a release of the locking unit 4a and hence a release of the side rail portion 3a. The side rail portion 3a can be retracted together with the actuating shaft 6, whereby the actuating shaft 6 enters into engagement with the locking unit 4b of the next lower side rail portion 3b. A combined view of FIGS. 4 and 5 shows that here and preferably the actuating shaft 6 penetrates the locking unit 4b with its free end 6a. A subsequent actuation of the actuating device 5 then leads correspondingly to a release of the locking unit 4b and of the associated side rail portion 3b.

From this representation it becomes clear why the actuating shaft 6 must penetrate the respective locking unit 4 with its free end 6a. Otherwise the actuating shaft 6 could not enter into engagement with the respectively next lower locking unit 4.

In the above retraction, a coherent rung pack, which preferably is indivisible, is formed at the upper end of the ladder. In order to achieve this, it is preferably provided that the locking units 4 of the side rail portions 3 respectively have an activatable coupling unit 8 for the coupling thereof to a further locking unit 4. This further locking unit 4 is here and preferably always constituted by the locking unit 4 of the next higher, retracted side rail portion 3. The locking units 4a of the topmost side rail portions 3a are not equipped with such a coupling unit 8. The coupling here acts in the direction of extent of the respective side rail 1.

Particularly interesting in the represented illustrative embodiment is the fact that the release of a locking unit 4 by the actuating device 5 is accompanied by an activation of the coupling unit 8. This is illustrated below on the basis of the example of the retraction of the side rail portions 3a, 3b, starting from the extended ladder according to FIG. 5.

In the retraction of the side rail portion 3a, its locking unit 4a enters into engagement with the locking unit 4b of the next lower side rail portion 3b, whereupon a subsequent release of the lower of the two locking units 4a, 4b, here, therefore, of the locking unit 4b, by the actuating device 5 effects a coupling of the two locking units 4a, 4b one to another and hence a coupling of the assigned side rail portions 3a, 3b one to another.

By virtue of the fact that, here and preferably, the locking units 4 of those side rail portions 3 which are not in the extended setting are always released and that the corresponding coupling units 8 are here, correspondingly, always activated, upon the subsequent further retraction of the ladder the two locking units 4a, 4b remain coupled together. Upon further retraction of the ladder, the two locking units 4a, 4b enter into engagement with the locking unit 4c of the next lower side rail portion 3c and, upon subsequent actuation by the actuating device 5, are correspondingly coupled to this locking unit 4c.

It is apparent from the above explanation that, here and preferably, the locking units 4 of all retracted side rail portions 3 are coupled one to another, and further that the locking units 4 of all retracted side rail portions 3 are penetrated by the actuating shaft 6. This is also made clear by a combined view of FIGS. 4 and 5.

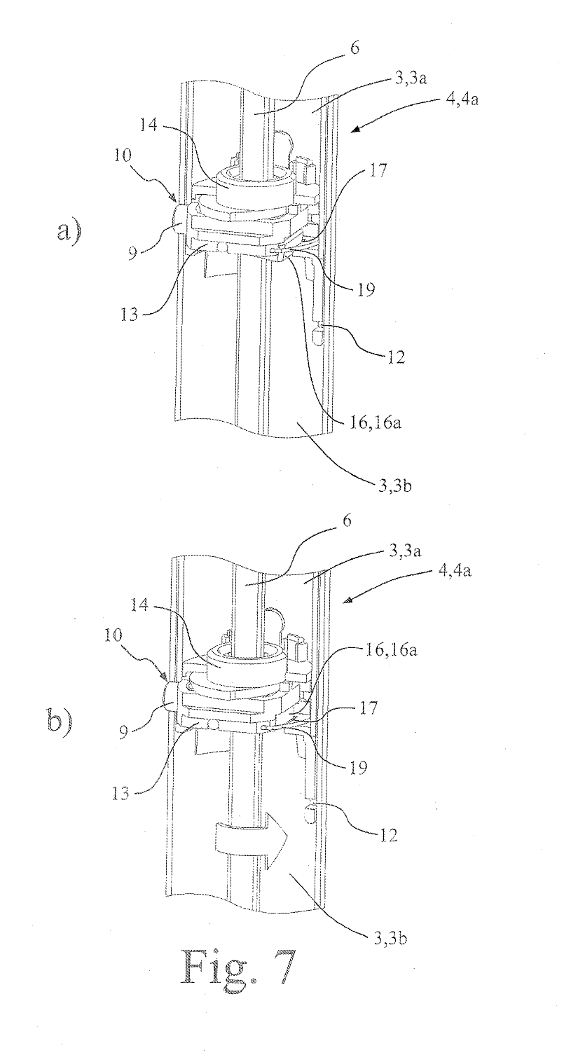

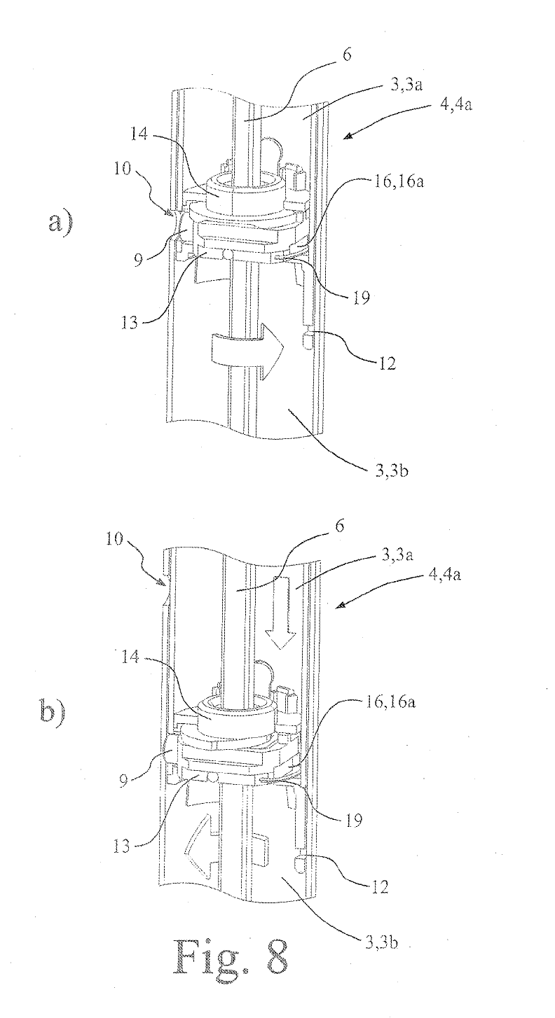

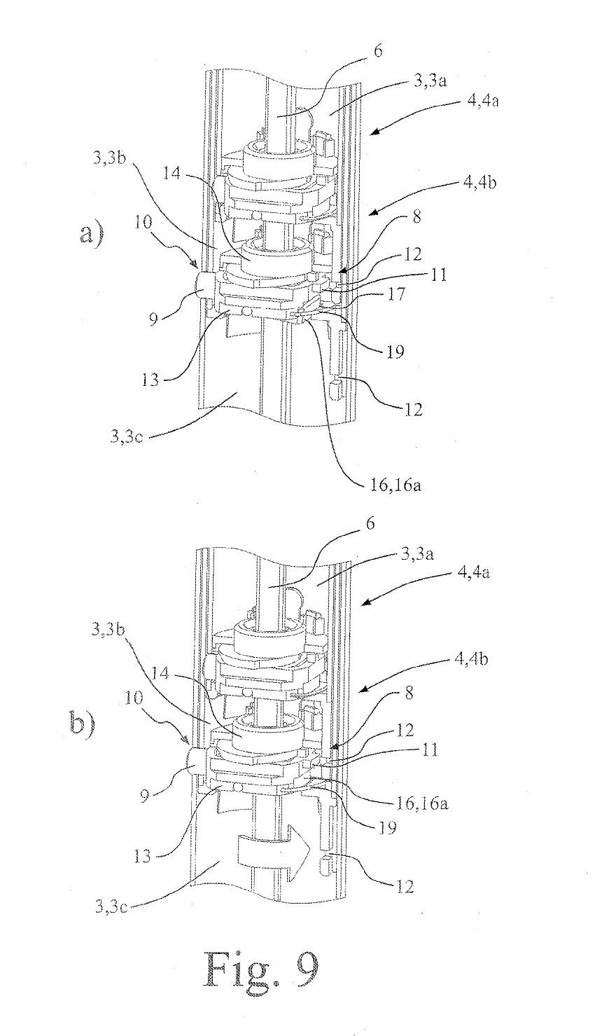

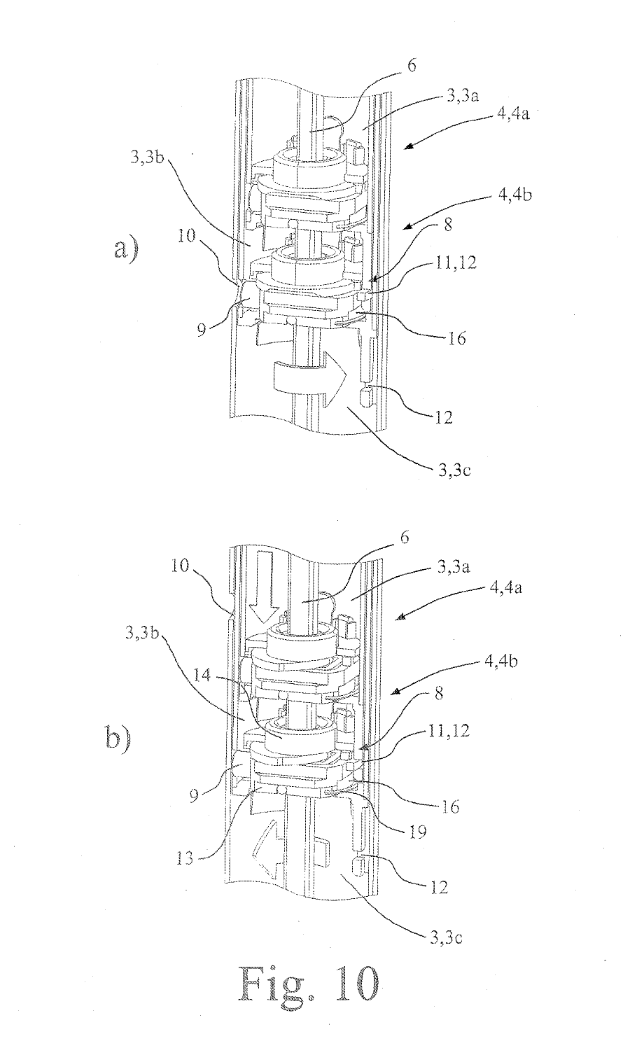

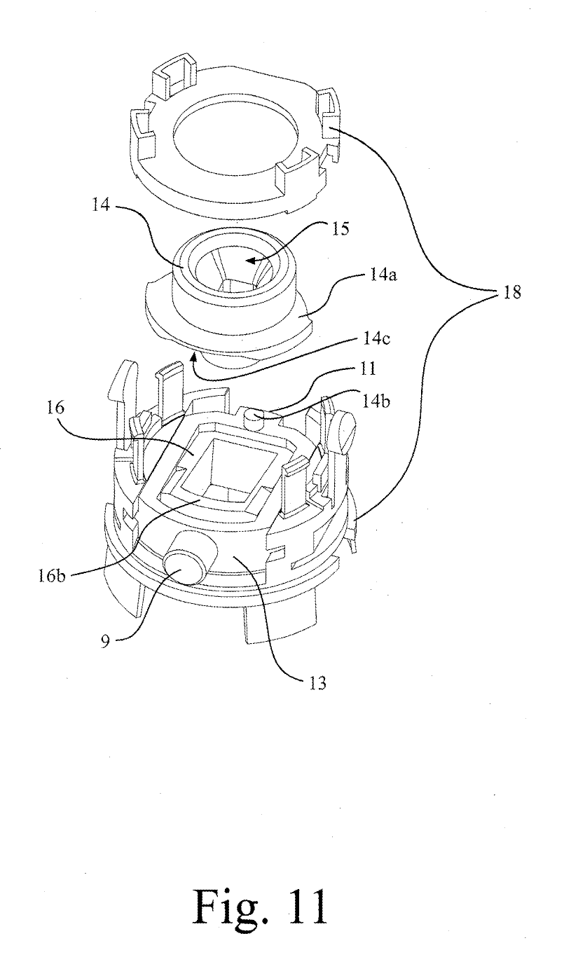

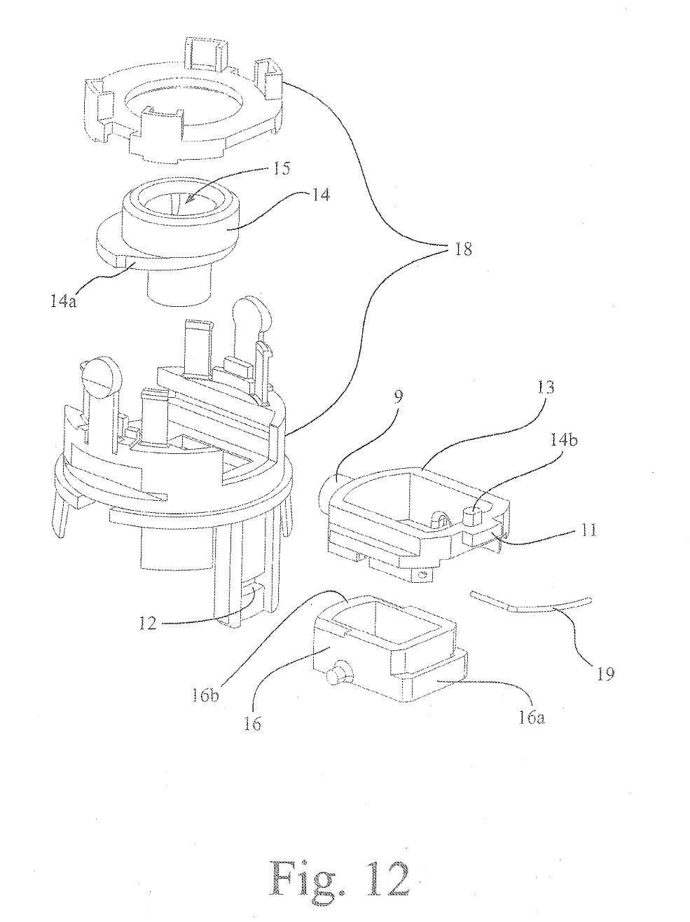

FIGS. 7 to 10 show the locking units 4 in detail in the mounted state. The locking units 4 which are represented there are constituted by the locking units 4a of the topmost side rail portions 3a (FIGS. 7, 8) and, in addition, by the locking units 4b of the next lower side rail portions 3b (FIGS. 9, 10). The configuration of the respective individual parts can be seen from FIGS. 11 and 12.

It should be borne in mind that all locking units 4 with the exception of the locking unit 4a of the topmost side rail portion 3a are structurally identical, except for necessary variances in dimensioning which are geared to the dimensioning of the respective side rail portions 3. The locking unit 4a of the topmost side rail portion 3a is configured differently only insofar as a coupling unit 8 in the above sense is not realized there.

It can thus be seen from the representation in FIG. 7 that the there locking unit 4a has an adjustable locking element 9 for the positive locking against the respectively next lower side rail portion, here against the side rail portion 3b. The locking element 9 is in a locking setting (FIG. 7a)) or in a release setting (FIG. 8a)), according to the locking state.

More specifically, the locking element 9, for locking to the next lower side rail portion 3b, engages in a locking indent 10, which here and preferably is configured as a simple bore in the side rail portion 3b. The locking element 9 is here correspondingly in the locking setting.

In principle, the locking indent 10 can be provided at different places on the respective side rail portion 3. Here and preferably, the locking indent 10, when the ladder is extended, is respectively disposed between two rungs 2. This can be seen, for instance, from the representation in FIG. 6.

The locking element 9 can now be adjusted by means of the actuating device 5, via the actuating shaft 6, into the release setting, in which the locking element 9 is disengaged from the locking indent 10. This is represented, for instance, in FIG. 8a). Here it is further preferably the case that the locking element 9 is biased into the locking setting by a spring element 19.

The coupling unit 8 of the locking unit 4b is represented in FIGS. 9 and 10. The coupling unit 8 has there an adjustable coupling element 11 for positive coupling to a further locking unit 4a, the coupling element 11 being in an activated setting (FIG. 10) or in a deactivated setting (FIG. 9), according to the coupling state. Here and preferably, upon activation of the coupling unit 8, the coupling element 11 enters into engagement with a coupling indent 12 of the further locking unit 4a. This naturally presupposes that, as here, the upper locking unit 4a has previously been brought into engagement with the lower locking unit 4b.

A look at FIG. 12 shows that the coupling element 11 is here and preferably integrally connected to the locking element 9, so that the release of the locking unit 4 is always accompanied by an activation of the coupling unit 8. Of course, a non-integral connection is also possible here.

More specifically, the locking element 9 and the coupling element 11 are disposed on an actuating slide 13, the actuating slide 13 being adjustable, within the framework of an actuation by the actuating device 5, substantially perpendicular to the extent of the respective side rail 1. This can best be seen from a combined view of FIGS. 11 and 12. In principle, it can also be provided that only one of the components locking element and coupling element is disposed on the actuating slide 13. A realization of two mutually coupled actuating slides is also conceivable.

The mechanical interface between the actuating shaft 6 and the respective locking unit 4 is preferably realized by the locking unit 4 having a rotatable actuating element 14, which is further preferably configured as an actuating cam. Through the rotation of the actuating element 14, a deflection of the locking element 9 into the release setting and, according to the design configuration, a deflection of the coupling element 11 into the activated setting can be effected. For this, the actuating element 14 is equipped with a cam 14a, which cooperates with a driver 14b disposed on the actuating slide 13.

The actuating element 14 now has a driving opening 15 aligned to the actuating shaft axis, with which driving opening the actuating shaft 6 enters into engagement upon the retraction of the respective side rail portion 3 and through which the actuating shaft 6 can be guided. It is here preferably the case that the actuating shaft 6, in the retraction of the respective side rail portion 3, is axially movable, but enters into engagement in a rotationally secure manner with the driving opening 15 of the actuating element 14. Here, the realization of a corresponding form closure between the actuating shaft 6 and the actuating element 14 is advantageous. Correspondingly, the driving opening 15, on the one hand, and the actuating shaft 6, on the other hand, can be configured in cross section in the manner of a square or hexagonal profile or in the manner of a pinion. Other positive-locking connections are conceivable.

The locking units 4 of the represented illustrative embodiment have a further peculiarity with which the operating reliability of the proposed ladder is further enhanced. This peculiarity serves namely to prevent the locking units 9, here the locking pins 9, from being forced out of the locking indents 10 from outside in the event of incorrect use.

FIG. 7a) shows that an expulsion of the locking element 9, to the right in the representation shown there, would in principle be possible as a result of the accessibility of the locking element 9 from outside. In order to prevent this, the locking unit 4 has an adjustable blocking element 16, which blocks an adjustment of the locking element 9 out of the locking setting, a first rotation of the actuating element 14, within the framework of the actuation, bringing about a cancellation of the blocking by the blocking element 16. This means that the blocking element 16 acts always in a blocking manner on the locking element 9 as long as a first rotation of the actuating element 14 is not yet executed.

A preferred realization of the above blocking of the locking element 9 can be seen from the representation in FIGS. 7 to 12. The blocking element 16 is here attached pivotably to the actuating slide 13. This is shown, for instance, by a combined view of FIGS. 11 and 12. The working method of the blocking element 16 is best shown from the representation in FIG. 7. Without actuation, the locking element 9 is in the locking setting and the blocking element 16 in the blocking setting. In this case, the blocking element is pivoted downward in FIG. 7a). If a force is now applied to the locking element 9 to the right in FIG. 7a), then a blocking face 16a of the blocking element 16 enters into engagement with a shoulder 17 of the housing 18 of the locking unit 4a. Through the attachment of the blocking element 16 to the actuating slide 13, the adjustment of the actuating slide 13 is blocked.

Not until a first rotation of the actuating element 14 does a connecting link 14c (FIG. 11) enter into engagement with a guide face (16b) of the blocking element 16 and force the blocking element 16 into the position represented in FIG. 7b). This is preferably effected counter to the force of a spring element (not represented).

After this, it is possible to displace the actuating slide 13 in FIG. 7b) to the right. The blocking face 16a of the blocking element 16 here runs past the shoulder 17 of the housing 18.

The above solution for blocking of the locking element 9 is simple and robust. In order to reduce the number of parts, it would be conceivable to connect the blocking element 16 as a tongue or the like integrally to the actuating slide 13.

The step-by-step retraction of the side rail portions 3a, 3b is now explained below with reference to FIGS. 7 to 10.

Starting from the unactuated state represented in FIG. 7a), a first rotation of the rotary actuating handle 7 in the rotational direction shown in FIG. 7b) firstly effects a cancellation of the blocking by the blocking element 16. Further actuation leads to an engagement of the cam 14a with the driver 14b and hence to an adjustment of the locking element 9 into the release setting (FIG. 8a)).

While the side rail portion 3a, together with the locking unit 4a, is being retracted into the side rail portion 3b, the user releases the rotary actuating handles 7, which thereupon snap back into their original setting. This is shown in FIG. 8b). The locking element 9, which is in the release setting, hereupon slides on the inner wall of the side rail portion 3a. It is thereby ensured that a locking unit 4 of a non-extended side rail portion 3 which bears constantly, of course, against the inner wall of a side rail portion is always released. This applies correspondingly, in principle, to all further locking units 4, in the case of the further locking units 4 the coupling unit 8, too, which is present there additionally being held in the activated state.

Following the retraction of the side rail portion 3a, the locking unit 4a enters into engagement with the locking unit 4b of the next lower side rail portion 3b. Prior to this, the actuating shaft 6 further penetrates the actuating element 14 of the locking unit 4b, so that a first actuation firstly effects the cancellation of the blocking by the blocking element 16 (FIG. 9b) there.

Upon further actuation, the locking element 9 of the locking unit 4b is now transferred into the release setting (FIG. 10a)). At the same time, the coupling element 11 of the locking unit 4b enters into engagement with the coupling indent 12 of the locking unit 4a. The side rail portion 3b is now retractable into the next lower side rail portion 3c (FIG. 10b)). By virtue of the fact that, during this retraction, the locking element 9 of the locking unit 4b slides along the inner side of the side rail portion 3c, the coupling element 11 remains in the activated setting. The two locking elements 4a, 4b are coupled to each other until a further action occurs.

The above procedure can now be carried out successively for the next lower side rail portions 3d, e, until the retracted setting of the ladder represented in FIG. 4a) is reached overall.

The extension of the ladder out of the retracted setting represented in FIG. 4a) can easily be realized in the reverse manner, though without the need for actuation by the actuating device 5. For the extension operation, it is merely necessary to raise the rung pack comprising the rungs 2. By virtue of the fact that all locking units 4 are coupled to one another as explained above, only the extension of the side rail portions 3e is possible. The spring-biased locking element 9 of the locking unit 4e here snaps into the corresponding locking indent 10, which is accompanied by a transfer of the coupling element 11 of the locking unit 4e into the deactivated setting. It is hence now possible for the next higher side rail portion 3d to be extended in the same way. This procedure continues until the desired telescoping position of the ladder is reached. A mishandling of the ladder is broadly precluded.

What is claimed is:

1. A telescopic ladder having two adjacent side rails and rungs disposed between the side rails, the side rails respectively comprising a plurality of substantially tubular, telescoping side rail portions, mutually adjacent side rail portions being respectively connected to one another by a rung,
wherein the side rail portions have a locking unit, with which the side rail portions can be locked against the next lower side rail portion in the extended setting, wherein to each of the two side rails there is assigned a manual actuating device for the release of the locking units, and wherein the actuating device has an actuating shaft, which runs along within the respective side rail and which, is capable of engaging at least one locking unit.

2. The ladder as claimed in claim 1, wherein the locking units are rigidly connected to the side rail portions.

3. The ladder as claimed in claim 1, wherein the actuating device has at the upper end of the respective side rail a rotary actuating handle, which is drive-coupled to the actuating shaft.

4. The ladder as claimed in claim 1, wherein the actuating shaft extends downward from the upper end of the respective side rail with a free end.

5. The ladder as claimed in claim 1, wherein the actuating shaft is designed such that it is engaged with the locking unit of the respectively topmost extended side rail portion, and not with locking units of other extended side rail portions.

6. The ladder as claimed in claim 1, wherein (a) the length of the side rail portions is about 1.5 times the distance between two rungs when the ladder is extended, (b) the length of the actuating shaft is about twice the distance between two rungs when the ladder is extended, or both (a) and (b).

7. The ladder as claimed in claim 1, wherein, when a side rail portion is retracted, the actuating shaft enters into engagement with the locking unit of the next lower side rail portion.

8. The ladder as claimed in claim 1, wherein the locking units of the side rail portions, with the exception of the locking units of the topmost side rail portions, have an activatable coupling unit for the coupling thereof to a further locking unit.

9. The ladder as claimed in claim 1, wherein, during the retraction of a side rail portion, its locking unit enters into engagement with the locking unit of the next lower side rail portion, and wherein a subsequent release of the lower of the two locking units by the actuating device effects a coupling of the two locking units one to another and hence a coupling of the assigned side rail portions one to another.

10. The ladder as claimed in claim 1, wherein a locking unit of a side rail portion which is not in the extended setting is released, and wherein the coupling unit is activated.

11. The ladder as claimed in claim 1, wherein (a) the locking units of all retracted side rail portions are coupled one to another, (b) the locking units of all retracted side rail portions are penetrated by the actuating shaft, or both (a) and (b).

12. The ladder as claimed in claim 1, wherein the locking units have an adjustable locking element for the positive locking against the next lower side rail portion, wherein the locking element is in a locking setting or in a release setting, according to the locking state, and for locking to the next lower side rail portion, standing in the locking setting, engages in a locking indent which is present there, in particular a bore.

13. The ladder as claimed in claim 12, wherein the locking element is adjustable by means of the actuating device into the release setting, in which the locking element is disengaged from the locking indent.

14. The ladder as claimed in claim 8, wherein the coupling unit of the respective locking unit has an adjustable coupling element for positive coupling to a further locking unit, and wherein the coupling element is in an activated setting or in a deactivated setting, according to the coupling state.

15. The ladder as claimed in claim 12, wherein the coupling element is integrally connected to the locking element, so that the release of a locking unit is always accompanied by an activation of the assigned coupling unit.

16. The ladder as claimed in claim 1, wherein the locking element, the coupling element, or both are disposed on an actuating slide, and wherein the actuating slide is adjustable, within the framework of an actuation, substantially perpendicular to the extent of the respective side rail.

17. The ladder as claimed in claim 1, wherein the locking unit has a rotatable actuating element, through whose rotation a deflection of the locking element into the release setting and/or a deflection of the coupling element into the activated setting can be effected.

18. The ladder as claimed in claim 1, wherein the actuating element has a driving opening aligned to the actuating shaft axis, with which driving opening the actuating shaft enters into driving engagement upon the retraction of the respective side rail portion and through which the actuating shaft can be guided.

19. The ladder as claimed in claim 18, wherein the actuating shaft, during retraction of the respective side rail portion, is axially movable, but enters into engagement in a rotationally secure manner with the driving opening of the actuating element.

20. The ladder as claimed in claim 1, wherein the locking unit has an adjustable blocking element, which blocks an adjustment of the locking element out of the locking setting.
